(19) United States
(12) Patent Application Publication
(10) Pub. No.: US 2023/0222679 A1
(43) Pub. Date: Jul. 13, 2023

(54) INDOOR SPACE POSITIONING METHOD AND INDOOR SPACE POSITIONING SYSTEM

(71) Applicant: HTC Corporation, Taoyuan City (TW)

(72) Inventor: Yung-Hung CHEN, Taoyuan City (TW)

(73) Assignee: HTC Corporation, Taoyuan City (TW)

(21) Appl. No.: 17/984,613

(22) Filed: Nov. 10, 2022

Related U.S. Application Data
(60) Provisional application No. 63/297,380, filed on Jan. 7, 2022.

(51) Int. Cl. G06T 7/579; G06T 7/70; G02B 27/01; G06K 7/14

(52) U.S. Cl. CPC G06T 7/579; G06T 7/70; G02B 27/0101; G02B 27/017; G06K 7/1417; G06T 2207/30244; G02B 2027/0138; G02B 2027/014

(57) ABSTRACT

An indoor space positioning method includes capturing an initial image using the camera in a head-mounted display (HMD) and enabling the transmission interface to download from a server the initial share map that corresponds to the initial image. The processor in the head-mounted display locates the head-mounted display at an initial location in an indoor space.

### BACKGROUND OF THE INVENTION

### Field of the Invention

The present invention relates to a positioning method, and, in particular, to an indoor space positioning method and indoor space positioning system applicable to indoor space.

### Description of the Related Art

Generally, outdoor space positioning can be performed using Global Positioning System (GPS) technology. For example, a cellphone's location may be quickly determined by receiving a satellite signal through the GPS function in the cellphone. The GPS function may also be combined with a navigation application to achieve multiple services related to displaying and/or sharing location.

However, as GPS signals cannot be received indoors, indoor positioning requires a hardware beacon using Bluetooth, Radio Frequency Identification (RFID), Zigbee, etc. . . . . This solution is costly and complicated to set up, however. If characteristic points in the environment are used to create anchors, the environmental characteristics need to be scanned, which can easily cause the identification to fail, or at least affect the accuracy, due to ongoing changes to the environment.

Thus, how to obtain same tracking and positioning results between different users indoors has become one of the problems to be solved in this field.

### BRIEF SUMMARY OF THE INVENTION

An embodiment of the present invention provides an indoor space positioning method. The indoor space positioning method comprises capturing an initial image using a camera in a head-mounted display (HMD). The method comprises enabling a transmission interface to download an initial share map that corresponds to the initial image from a server. The method comprises locating the head-mounted display at an initial location in an indoor space, using the processor in the head-mounted display. The method comprises applying a simultaneous localization and mapping (SLAM) algorithm to track a current location of the head-mounted display using the processor.

In an embodiment, the initial image is a QR code (Quick Response Code). The server determines that the head-mounted display is at the initial location in the indoor space according to information represented by the QR code.

In an embodiment, the processor in the head-mounted display enables the transmission interface to download from the server an important share map that corresponds to the respective important QR codes.

In an embodiment, the processor in the head-mounted display enables the transmission interface to download a plurality of partial share maps which are within a spatial range of the initial share map that corresponds to the initial image from the server.

In an embodiment, the processor in the head-mounted display enables the transmission interface to download a plurality of partial share maps which are adjacent to the initial share map that corresponds to the initial image from the server.

In an embodiment, the indoor space is divided into a plurality of blocks via the processor, each of the blocks corresponding to a partial share map. The processor in the head-mounted display enables the transmission interface to download from the server the partial share maps which surround the initial share map that corresponds to the initial image.

In an embodiment, the processor enables the transmission interface to download from the server a current share map that corresponds to a current location and a plurality of current partial maps adjacent to the current share map, when the head-mounted display moves.

In an embodiment, the processor downloads a plurality of important share maps from the server first when the processor applies the simultaneous localization and mapping algorithm to track the current location of the head-mounted display.

In an embodiment, the processor downloads a plurality of secondary share maps from the server after the processor downloads the important share maps from the server.

In an embodiment, when the processor tracks the head-mounted display and detects that the head-mounted display moves to a current location, the camera captures a current image, and the processor enables the transmission interface to transform the current image into a plurality of characteristic values and generate space information. It then transmits the characteristic values and the space information to the server. The server applies the characteristic values and the space information to update a partial map that corresponds to the current location thereby building a new version of partial map, wherein the server updates the map version number and stores the new version of partial map, after the new version partial map is built.

An embodiment of the present invention provides an indoor space positioning system comprising a camera and a processor. The camera is arranged in a head-mounted display (HMD) and configured to capture an initial image. The processor is arranged in the head-mounted display, and the processor enables a transmission interface to download an initial share map that corresponds to the initial image from a server and locates the head-mounted display at an initial location in an indoor space. Wherein the processor applies a simultaneous localization and mapping (SLAM) algorithm to track a current location of the head-mounted display.

In an embodiment, the initial image is a QR code (Quick Response Code), the server determines that the head-mounted display is at the initial location in the indoor space according to information represented by the QR code.

In an embodiment, the transmission interface is enabled to download an important share map that corresponds to the respective important QR codes from the server via the processor in the head-mounted display.

In an embodiment, the processor in the head-mounted display enables the transmission interface to download a plurality of partial share maps which are within a spatial range of the initial share map that corresponds to the initial image from the server.

In an embodiment, the processor in the head-mounted display enables the transmission interface to download a plurality of partial share maps which are adjacent to the initial share map that corresponds to the initial image from the server.

In an embodiment, the processor divides the indoor space into a plurality of blocks, each of the blocks corresponds to a partial share map. Wherein the processor in the head-mounted display enables the transmission interface to download the partial share maps which surround the initial share map that corresponds to the initial image from the server.

In an embodiment, when the head-mounted display moves, the processor enables the transmission interface to download from the server a current share map that corresponds to a current location and a plurality of current partial maps adjacent to the current share map.

In an embodiment, the processor downloads a plurality of important share maps from the server first when the processor applies the simultaneous localization and mapping algorithm to track the current location of the head-mounted display.

In an embodiment, the processor downloads a plurality of secondary share maps from the server after the processor downloads the important share maps from the server.

In an embodiment, when the processor tracks the head-mounted display and detects that the head-mounted display moves to a current location the camera captures a current image, the processor enables the transmission interface to transform the current image into a plurality of characteristic values and generate space information. It then transmits the characteristic values and the space information to the server. The server applies the characteristic values and the space information to update a partial map that corresponds to the current location thereby building a new version of partial map, wherein the server updates a map version number and stores the new version of partial map, after the new version partial map is built.

As described above, the embodiments of the present invention provide an indoor space positioning system and an indoor space positioning method, which can implement the effect of obtaining same tracking positioning results between different users in the indoor by downloading the partial share map. The embodiments of the present invention can also perform more precise positioning and/or updating the positioning information of the indoor space by dividing the indoor space into multiple blocks.

### BRIEF DESCRIPTION OF THE DRAWINGS

The present invention can be more fully understood by reading the subsequent detailed description and examples with references made to the accompanying drawings, wherein:

FIG. 1 shows a schematic diagram of an indoor space according to an embodiment of the present disclosure;

FIG. 2 is a flow diagram of an indoor space positioning method according to an embodiment of the present disclosure;

FIG. 3 shows a schematic diagram of an indoor space positioning method according to an embodiment of the present disclosure;

FIG. 4 shows a schematic diagram of an application of an indoor space positioning method according to an embodiment of the present disclosure;

FIG. 5 shows a schematic diagram of an application of an indoor space positioning method according to an embodiment of the present disclosure;

FIG. 6 shows a schematic diagram of an application of an indoor space positioning method according to an embodiment of the present disclosure;

FIG. 7 shows a schematic diagram of an indoor space division method according to an embodiment of the present disclosure;

FIG. 8 shows a schematic diagram of an indoor space division method according to an embodiment of the present disclosure;

FIG. 9 is a flow diagram of an indoor space division method according to an embodiment of the present disclosure;

FIG. 10 shows a schematic diagram of an indoor space division method according to an embodiment of the present disclosure;

FIG. 11 is a flow diagram of a method for downloading a share map according to an embodiment of the present disclosure; and

FIG. 12 is a flow diagram of a method for uploading an updated share map according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

It should be understood that, terms “include”, “comprise” used in the specification are used to describe the existences of particular technical features, values, method steps, operation processing, components, and/or assemblies and do not exclude adding more technical features, values, method steps, operation processing, components, assemblies, or any combination of the above.

Terms “first”, “second, “third” used in the claims are configured to modify the components in the claims and are not configured to represent the priority order, prior relationship, or one component ahead of another component there between, or the time order when performing the method steps. Those terms are only configured to distinguish components with the same name.

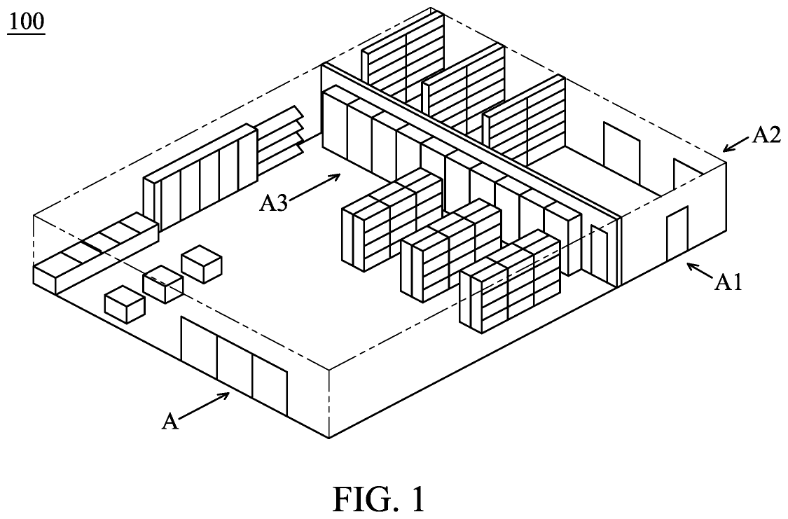

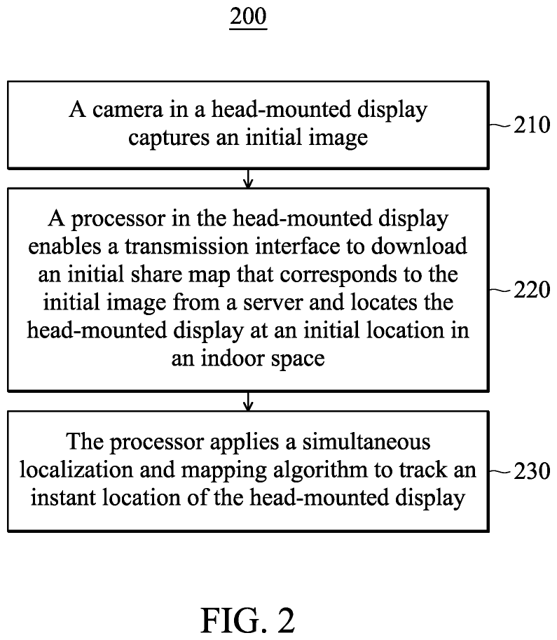

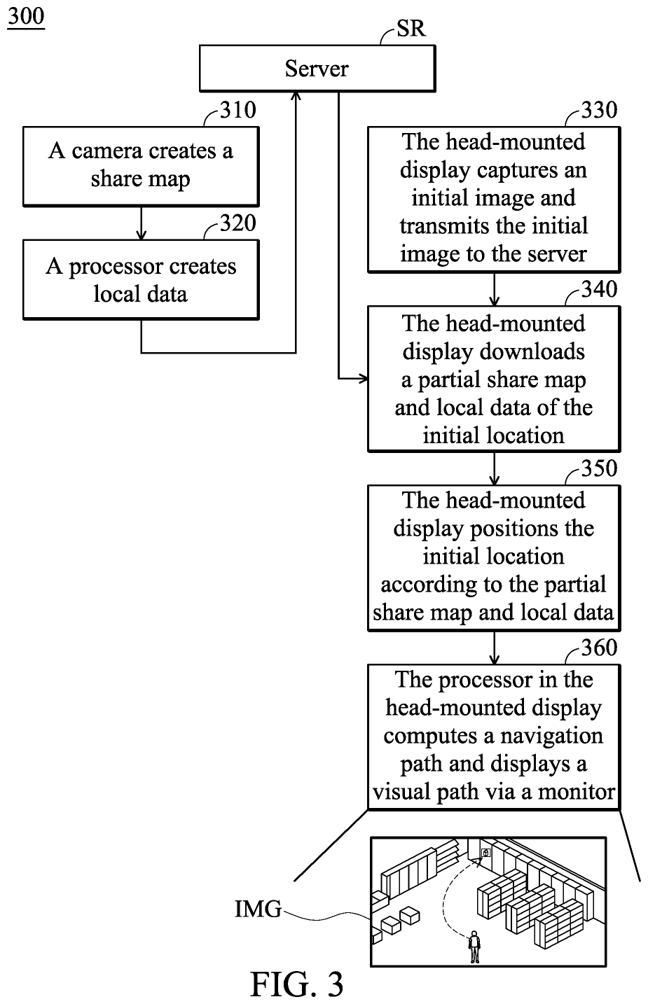

Please refer to FIGS. 1-3. FIG. 1 shows a schematic diagram of an indoor space 100 according to an embodiment of the present disclosure. FIG. 2 is a flow diagram of an indoor space positioning method 200 according to an embodiment of the present disclosure. FIG. 3 shows a schematic diagram of an indoor space positioning method 300 according to an embodiment of the present disclosure.

In an embodiment, the indoor space 100, for example, is supermarket, hypermarket, department store, museum, and so on.

In an embodiment, a client can capture an initial image at positioning point A, A1, A2, or A3 through a display device end, such as a head-mounted display (HMD). The head-mounted display, for example, is virtual reality glasses or augmented reality glasses. The initial image may be configured to position one or more clients (i.e. users) (i.e., locate the client or determine the location of the client). For example, when indoor space is hypermarket, there may be multiple levels of indoor space. When the family is scattered shopping in the hypermarket, each family member can know each other's location through the indoor space positioning method 200.

In step 210, a camera in a head-mounted display (HMD) captures an initial image.

In step 220, a processor in the head-mounted display enables a transmission interface to download an initial share map that corresponds to the initial image from a server SR and locates the head-mounted display at an initial location in an indoor space.

In an embodiment, because the user is wearing the head-mounted display, the location of the head-mounted display represents the location of the user.

In step 230, the processor applies a Simultaneous Localization and Mapping (SLAM) algorithm to track an instant location of the head-mounted display.

In this way, after the processor in the server SR obtains the instant location of the head-mounted display, the processor can transmit the instant location back to the head-mounted display or the pre-bounded user cellphone (or other electric device). The user can share this instant location to other electric devices and let user's family and friends know the instant location of the user.

Please refer to FIG. 3. In step 310, a camera creates a share map. In an embodiment, the camera in step 310 may be the head-mounted display, or may be any camera, such as camera consists of at least one charge coupled device (CCD) or one complementary metal-oxide semiconductor (CMOS). In an embodiment, it is possible to capture pictures while walking in the indoor space 100 by manual means (for example, by store staff), and the pictures captured may be applied to create the share map.

In step 320, a processor creates local data. In an embodiment, the processor may be in the head-mounted display, or may be an external processor. For example, after the camera captures a plurality of pictures, the pictures are transmitted to an external electric device, and a processor in the external electric device creates the local data of the pictures. In an embodiment, the local data includes anchors, object labels (e.g. labeling milk tags on the images of milk bottles), obstacles, navigation, path planning and/or cloud lobby room ID . . . etc. in each image. Then, the processor transmits the local data to the server SR.

Wherein the cloud lobby room ID may be applied to number head-mounted displays of the whole family in the store. For example, the ID of father is 01, the ID of mother is 02, the ID of son is 03, the ID of daughter is 04, and IDs of the whole family are all in the cloud lobby room ID 003. In the subsequent application, when the locations of the whole family have been positioned and tracked, the locations of the whole family in the market can be known via these IDs by clicking on the cloud lobby room ID 003. For example, father (whose ID is 01) is in the electrical appliances area on the 2nd floor, mother (whose ID is 02) is in the fresh food area on the 1st floor, son (whose ID is 03) is in the toys area on the 2nd floor, and daughter (whose ID is 04) is in the household goods area on the 3rd floor.

Through steps 310˜320, the initial share map can be built and stored in the server SR. Steps 330˜360 are the process that the user applies the data in the server SR to perform positioning.

In step 330, the user stands to the initial position (such as positioning point A). The head-mounted display captures an initial image and transmits the initial image to the server SR.

In an embodiment, the initial position may be near the entrance, stair, or elevator of the indoor space 100. The maps correspond to these locations are regarded as important share maps.

In an embodiment, the initial image includes a QR code (Quick Response Code), or the initial image itself is QR code. The QR code is pre-set in the space, thus, the server SR can determine the initial position of the head-mounted display in the indoor space according to the information represented by the QR code. In an embodiment, the head-mounted display is responsible to interpret the image of the QR code and transform the image into the information represented by the QR code. This information may be the location of this QR code (the location relative to the whole indoor map, which may be a number of a square (such as block BK)).

In step 340, the head-mounted display downloads a partial share map and local data of the initial location.

In an embodiment, after receiving the initial image, the server SR computes the location of the initial image in the indoor space through known image identification algorithm and transmits the partial share map and local data corresponding to the initial location back to the head-mounted display.

The server SR will first transmit back the partial share map and local data which are near the user, because the data amount of the whole floor or the whole indoor space is too large to send in one time.

In an embodiment, multiple important share maps may also be transmitted to the head-mounted display in this step.

In step 350, the head-mounted display positions (i.e. locates or determines) the initial location according to the partial share map and local data.

In an embodiment, the processor in the head-mounted display tracks the instant location of the head-mounted display by applying the Simultaneous Localization and Mapping algorithm.

In an embodiment, the processor downloads a plurality of important share maps from the server SR first, when the processor in the head-mounted display tracks the instant location of the head-mounted display by applying the Simultaneous Localization and Mapping algorithm. In an embodiment, the important share map may be pre-defined, such as the partial share map near the entrance, stair, or elevator of the indoor space 100.

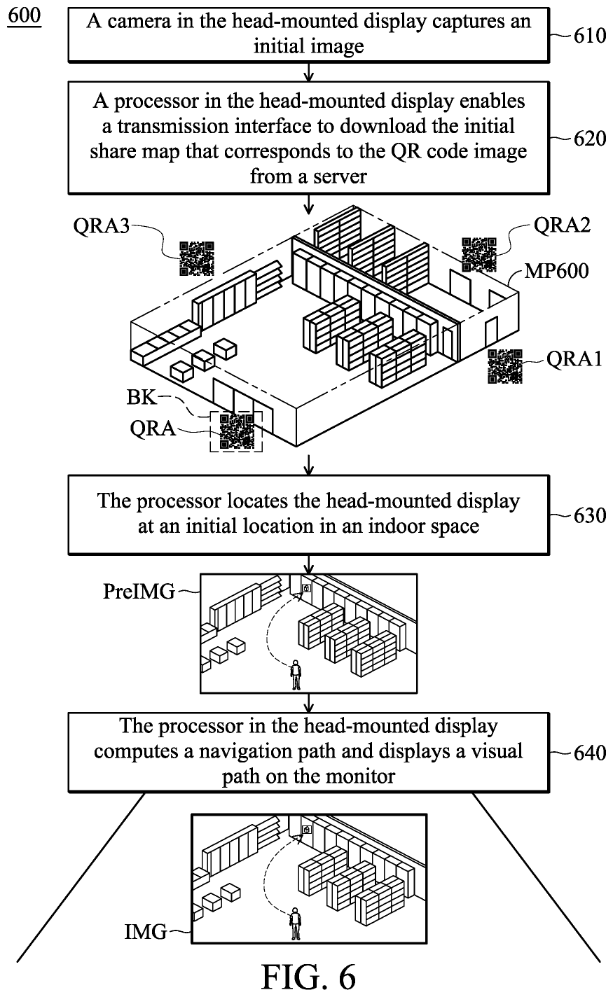

In an embodiment, when the initial image includes a QR code or the initial image itself is QR code, the processor in the head-mounted display enables the transmission interface to download an important share map that corresponds to the respective important QR codes (such as QR codes QRA, QRA1-A3 illustrated in FIG. 6) from the server SR. In an embodiment, the server SR does not store any image on it, no matter whether it is the image of the QR code or the image of the indoor scene. Thus, the QR code won't be downloaded to the head-mounted display.

By applying the QR code group in this way, multiple blocks of the important share maps in the share map can quickly be determined, and the important share map can be downloaded first. Moreover, the data amount of the QR code is small, so it is suitable to obtain multiple blocks of important share maps by building the QR code group.

After the important share map is downloaded, in the situation that the head-mounted display can't be tracked, as long as the user passes the important share map, for example when the user passes the location of the important share map, then the camera on the head-mounted display will capture the QR code, and the positioning and tracking can be performed again. Alternatively, when the user passes the location of the important share map, the processor on the head-mounted display performs step 340 again to download the partial share map and local data corresponding to the important share map after determines that the camera captures the image of the location of the important share map, and the positioning and tracking can be performed again.

In step 360, the processor in the head-mounted display computes a navigation path and displays a visual path via a monitor.

In an embodiment, the user can select the contents shown on the monitor of the head-mounted display, such as an indication of a path from the initial location (positioning point A) to the milk area. The processor in the head-mounted display will compute the navigation path (e.g. the best path) after receiving this indication, as illustrated in the image IMG. The processor marks the computed navigation path on the initial image and shows them together on the monitor.

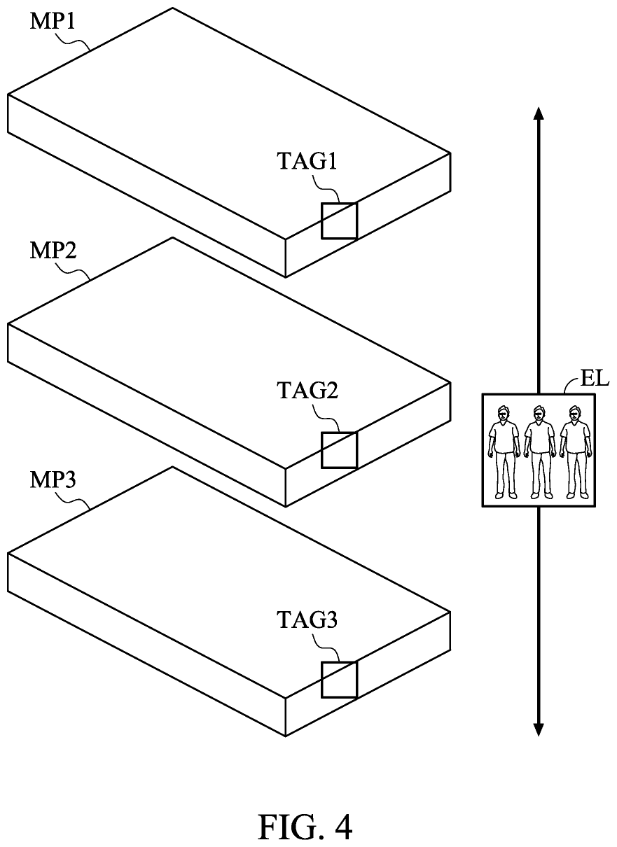

Please refer to FIG. 4, FIG. 4 shows a schematic diagram of an application of an indoor space positioning method 200 according to an embodiment of the present disclosure. The indoor space positioning method 200 can be applied to switch maps of different floors. As illustrated in FIG. 4, before the user enters an elevator EL, the camera of the head-mounted display will capture the image of the elevator EL, and the processor can determine that the user is going to capture the elevator EL, and the processor downloads the multiple important share maps first from the server SR.

In an embodiment, the important share map may be predefined, such as the partial share map of the elevator exit. By downloading the important share map in advance, the floor that the user arrived can be quickly positioned when the user walks out the elevator EL.

In an embodiment, the processor downloads a plurality of secondary share maps from the server SR after downloading these important share maps from the server SR.

In an embodiment, when the user walks out the elevator EL, the camera of the head-mounted display will capture the image of the elevator exit, such as an image TAG2 of the floor number MP2. The image may be a live view, QR code, or other representative characteristic. Similarly, the camera of the head-mounted display capturing the image of the elevator exit, such as an image TAG1 of the floor number MP1 or an image TAG3 of the floor number MP3, may also be positioned by the processor quickly.

In an embodiment, each floor may be assigned a different Wi-Fi code, Zigbee code, beacon, QR code, scene . . . etc., which may be downloaded to the head-mounted display in advance. After other sensors or transmission interfaces of the head-mounted display receive different information, other sensors or transmission interfaces of the head-mounted display may transmit these information to the processor, and the processor then determines the current floor according to these information.

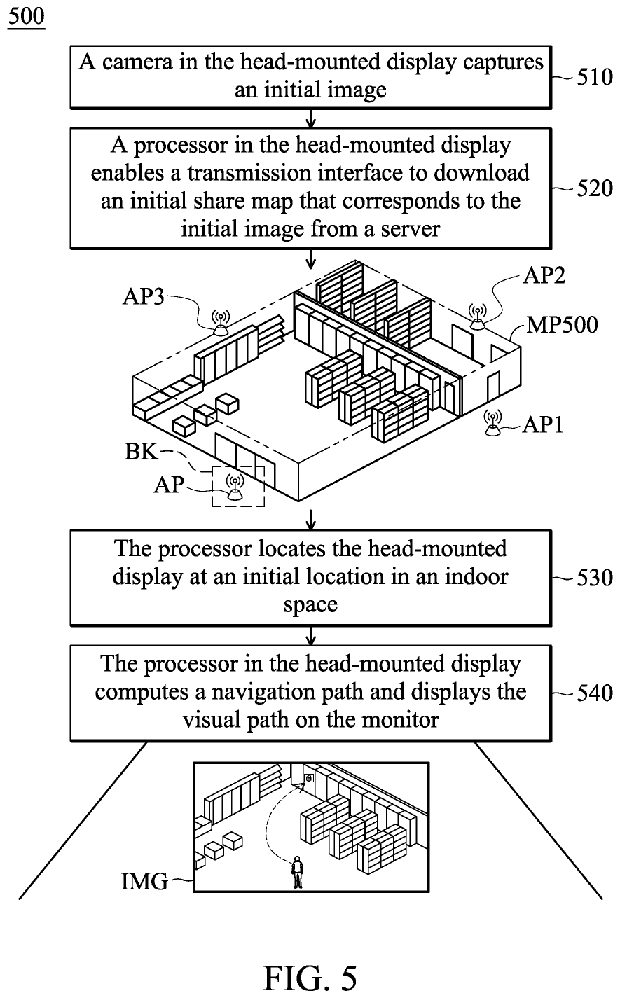

Please refer to FIG. 5. FIG. 5 shows a schematic diagram of an application of an indoor space positioning method 500 according to an embodiment of the present disclosure.

In step 510, a camera in the head-mounted display captures an initial image.

In step 520, a processor in the head-mounted display enables a transmission interface to download an initial share map that corresponds to the initial image from a server SR.

In an embodiment, the initial share map is one of the blocks of a share map MP500, such as the image of block BK.

In step 530, the processor locates the head-mounted display at an initial location in an indoor space.

In an embodiment, the processor may position the initial position of the head-mounted display in the indoor space by letting the user select locations on the share map MP500.

In an embodiment, the processor may locate the head-mounted display at the initial location in the indoor space through the signal (for example, Bluetooth signal from a signal transmitter AP (such as signal transmitters AP1˜AP3), Near Field Communication (NFC) communication near the block APBK, logos near the block APBK).

In step 540, the processor in the head-mounted display computes a navigation path and displays the visual path on the monitor.

In an embodiment, as illustrated in the image IMG, the processor marks the computed navigation path on the initial image and displays them together on the monitor.

Please refer to FIG. 6. FIG. 6 shows a schematic diagram of an application of an indoor space positioning method 600 according to an embodiment of the present disclosure

In step 610, a camera in the head-mounted display captures an initial image, which includes a QR code image.

In step 620, a processor in the head-mounted display enables a transmission interface to download the initial share map that corresponds to the QR code image from a server SR.

In an embodiment, the initial share map is one of the blocks of a share map MP600, such as the image of block BK.

In step 630, the processor locates the head-mounted display at an initial location in an indoor space.

In an embodiment, because the QR code is pre-set in the space, the server SR can determine the initial position of the head-mounted display in the indoor space according to the QR code.

In an embodiment, the processor applies the initial location corresponding to the QR code to generate a direction in the prediction scene and accelerates the data processing speed of displaying the positioning image to generate the prediction scene PreIMG.

In step 640, the processor in the head-mounted display computes a navigation path and displays a visual path on the monitor.

In an embodiment, as illustrated in the image IMG, the processor marks the computed navigation path on the initial image and displays them together on the monitor.

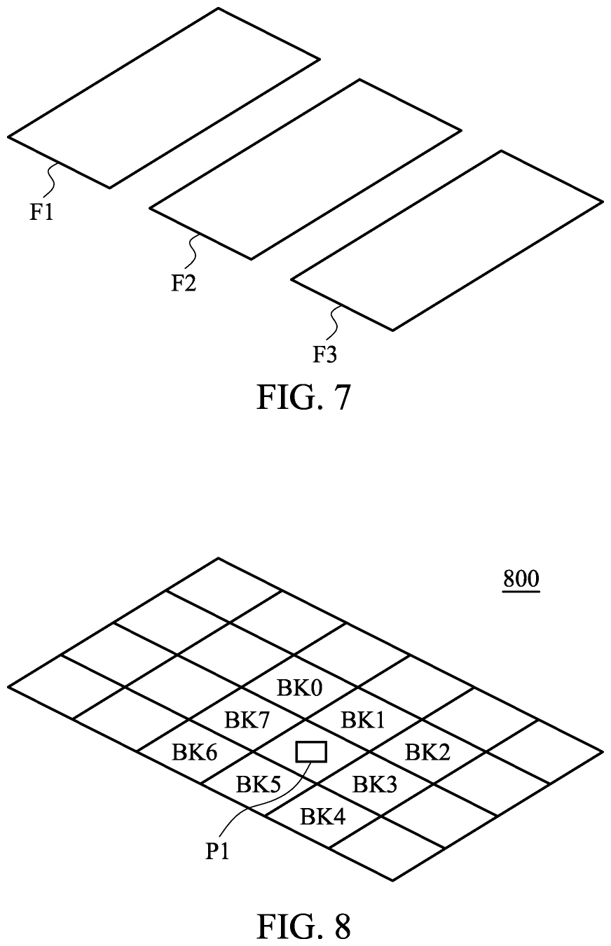

Please refer to FIG. 7. FIG. 7 shows a schematic diagram of an indoor space division method according to an embodiment of the present disclosure

In an embodiment, the processor may divide the indoor space after determining partial of or complete share map. For example, as illustrated in FIG. 7, the floor number MP1 of FIG. 4 is divided as block F1, the floor number MP2 of FIG. 4 is divided as block F2, the floor number MP3 of FIG. 4 is divided as block F3. Dividing the indoor space into blocks helps to position more precisely.

In an embodiment, the processor in the head-mounted display enables the transmission interface to download a plurality of partial share maps which are within a spatial range (such as the spatial range which are the upper and lower levels) near the initial share map that corresponds to the initial image (such as block F1) or the partial share maps near the initial share map from the server.

For example, block F1 is on the first floor, block F2 is on the second floor, block F3 is on the third floor. When the head-mounted device is in the block F1, the processor enables the transmission interface to download the partial share map of the block F2 from the server SR. When the head-mounted device is in the block F2, the processor enables the transmission interface to download the partial share maps of the block F1 and the block F3 from the server SR. When the head-mounted device is in the block F3, the processor enables the transmission interface to download the partial share map of the block F2 from the server SR.

Please refer to FIG. 8. FIG. 8 shows a schematic diagram of an indoor space 800 division method according to an embodiment of the present disclosure. In an embodiment, the indoor space 800 of the FIG. 8 is a store. The processor divides the indoor space 800 into 5*5 blocks according to a preset method. The preset method may be set in advance and may also be dynamically planned according to the number of pings of the indoor space 800, or may build rules of dividing methods corresponding to different types of the indoor space in advance. However, herein is not limited to this. One skilled in the art may select the method for dividing the blocks according to the actual indoor space.

In an embodiment, the processor in the head-mounted display enables the transmission interface to download a plurality of partial share maps which are adjacent to the initial share map that corresponds to the initial image from the server SR. For example, when the processor of the head-mounted display considers the image captured by the camera on position P1 as the initial image, the processor enables the transmission interface to download a plurality of partial share maps which are adjacent to the initial share map that corresponds to the initial image from the server SR. For example, except to downloading the share map of the block where location P1 is located, the processor enables the transmission interface to download the partial share maps of the blocks BK0˜7 which are adjacent to the location P1 from the server SR.

In an embodiment, the processor applies the Simultaneous Localization and Mapping algorithm to track the instant location of the head-mounted display. When the processor tracks that the head-mounted display moves to a current location P1, the camera captures a current image, and the processor transforms the current image into a plurality of characteristic values (for example, it identifies the characteristic points such as edges, corners, color blocks, etc. in the current image, and transforms these into values that represent each characteristic point, i.e. it generates a characteristic value) and generates space information, then transmits these characteristic values and space information to the server SR. The server SR applies these characteristic values and space information to update a partial map that corresponds to the current location thereby building a new version of partial map. After the new version of partial map has been built, the server SR updates a map version number and stores the new version of partial map.

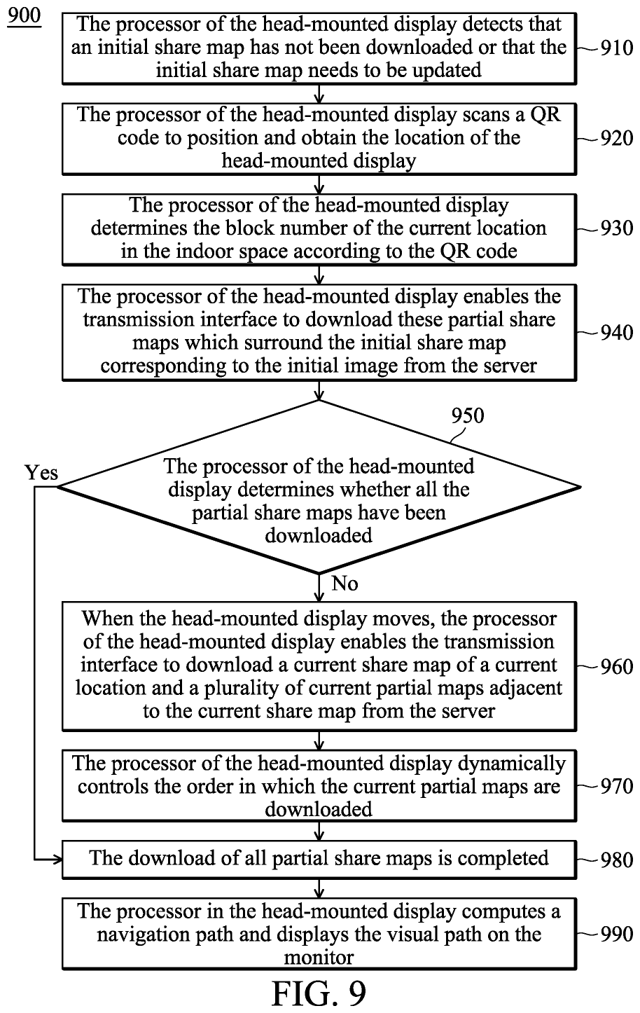

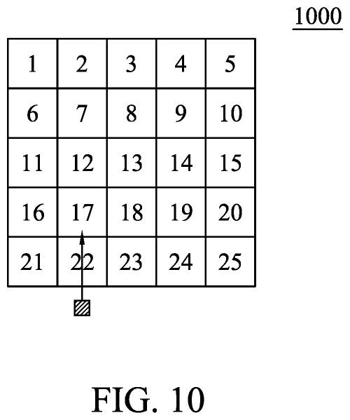

Please refer to FIGS. 9˜10. FIG. 9 is a flow diagram of an indoor space 900 division method according to an embodiment of the present disclosure. Please refer to FIG. 10. FIG. 10 shows a schematic diagram of an indoor space 1000 division method according to an embodiment of the present disclosure;

In an embodiment, the processor divides the indoor space 1000 into 25 blocks, each block corresponds to a partial share map. The processor in the head-mounted display enables the transmission interface to download these partial share maps (for example, the partial share maps are numbered 16˜18, 21, and 23) which surround the initial share map (for example, the initial share map is number 22) corresponding to the initial image from the server SR.

In an embodiment, when the head-mounted display moves (for example, moves to block 17), the processor enables the transmission interface to download a current share map (such as the current share map of the block 17) corresponding to a current location (such as block 17) and a plurality of current partial maps (such as the current partial maps of the blocks 11˜13, 16, 18, 21˜23) adjacent to the current share map from the server SR.

In an embodiment, not every movement of the head-mounted display will trigger the download of the partial map. For example, the download of the partial map will not be triggered if the head-mounted display is rotated in place or moved within a small area of the current share map.

In an embodiment, when the head-mounted display determines that the user will leave from the current share map and the move direction (for example, form the block 17 move to the block 16), the head-mounted uploads these information to the server SR as the conditions for the server SR to pre-determine which block should be downloaded.

In this way, the processor may provide the current partial map of the adjacent block instantly when the user continues to move to the adjacent block.

The following describes the indoor space 900 division method and takes FIG. 10 as example to illustrate.

In step 910, the processor of the head-mounted display detects that an initial share map has not been downloaded or that the initial share map needs to be updated.

For example, when the processor wants to access the initial share map from a storage device but finds out that this data is not available in the storage device, the processor determines that the initial share map has not been downloaded. Alternatively, the processor accesses the initial share map from the storage device but finds out that the initial share map is different from the live view of the current location, which means that the initial share map needs to be updated. These situations will trigger the processor to detect that the initial share map has not been downloaded or the initial share map needs to be updated.

In step 920, the processor of the head-mounted display scans a QR code to position and obtain the location of the head-mounted display.

The location of the head-mounted display is the location of the user. The current direction of the user may also be determined by scanning the QR code.

In an embodiment, QR code is only an example and the present invention is not limited to this. Beacons, scene . . . etc. may also be used to position the location.

In step 930, the processor of the head-mounted display determines the block number of the current location in the indoor space 1000 (for example, the initial share map is number 22, which is described as block 22 below, and other blocks are also described in the same way) according to the QR code.

In step 940, the processor of the head-mounted display enables the transmission interface to download these partial share maps (for example, the partial share maps are numbered 16˜18, 21, and 23) which surround the initial share map (for example, the initial share map is number 22) corresponding to the initial image from the server.

In step 950, the processor of the head-mounted display determines whether all the partial share maps (blocks 1˜25) have been downloaded. If yes, the method goes to step 980. If no, the method goes to step 960.

In step 960, when the head-mounted display moves (for example, moves to block 17), the processor of the head-mounted display enables the transmission interface to download a current share map (such as the current share map of the block 17) of a current location (such as block 17) and a plurality of current partial maps (such as the current partial maps of the blocks 11˜13, 16, 18, 21˜23) adjacent to the current share map from the server SR.

In step 970, the processor of the head-mounted display dynamically controls the order in which the current partial maps are downloaded.

In an embodiment, the processor downloads the important share map first and then downloads the secondary share map.

In step 980, the download of all partial share maps (blocks 1˜25) is completed.

In step 990, the processor in the head-mounted display computes a navigation path and displays the visual path on the monitor.

In this way, the processor in the head-mounted display computes the navigation path according to the updated new version of partial map and displays the visual path on the monitor.

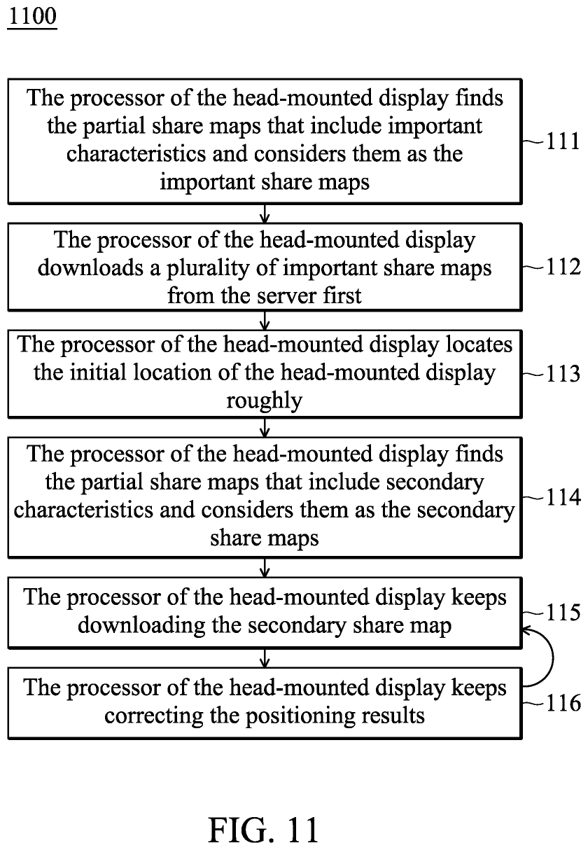

Please refer to FIG. 11. FIG. 11 is a flow diagram of a method 1100 for downloading a share map according to an embodiment of the present disclosure.

In step 111, the processor of the head-mounted display finds the partial share maps that include important characteristics and considers them as the important share maps.

In an embodiment, the important share maps may be defined in advance, such as the partial share map of the elevator exit. By downloading the important share map(s) in advance, the floor that the user arrived can be quickly positioned when the user walks out the elevator. The important share map(s) may be set with higher weight.

In an embodiment, the important share map may be the partial share map with higher identification success rate, such as the partial share map that includes more characteristic points.

In step 112, the processor of the head-mounted display downloads a plurality of important share maps from the server SR first.

In step 113, the processor of the head-mounted display locates the initial location of the head-mounted display roughly.

In an embodiment, due to the camera set on the head-mounted display, the processor of the head-mounted display can roughly positions the relative coordinates and/or line of sight orientation in the indoor space (such as indoor space 1000) of the head-mounted display (user).

In step 114, the processor of the head-mounted display finds the partial share maps that include secondary characteristics and considers them as the secondary share maps.

In an embodiment, the important share map may be defined in advance, such as the partial share map including particular arrangement. The weight of the important share map is higher than the weight of the secondary share map.

In steps 115˜116, the processor of the head-mounted display keeps downloading the secondary share map (step 115) and keeps correcting the positioning results (step 116).

In an embodiment, after the processor of the head-mounted display determines that all the blocks (such as FIG. 10) have been downloaded, this process ends.

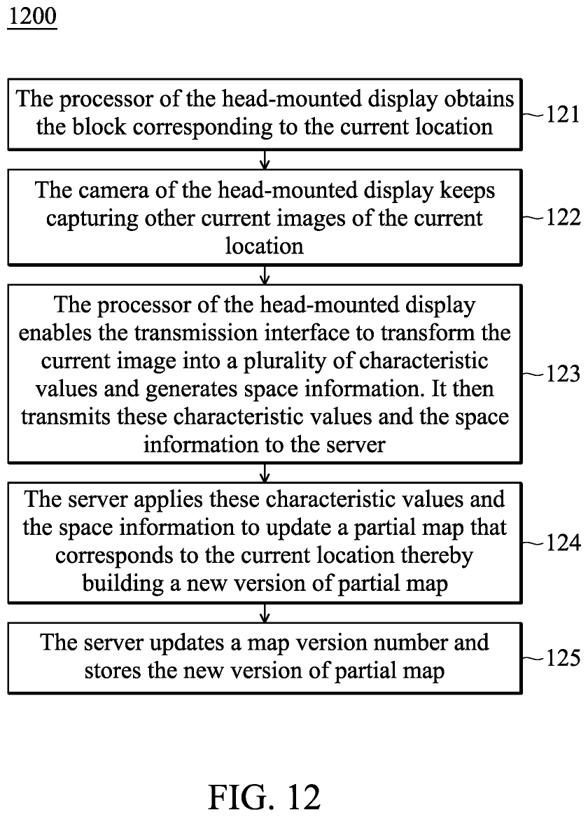

Please refer to FIG. 12, which is a flow diagram of a method 1200 for uploading a updated share map according to an embodiment of the present disclosure

In step 121, the processor of the head-mounted display obtains the block corresponding to the current location (such as block 17 of FIG. 10).

In step 122, the camera of the head-mounted display keeps capturing other current images of the current location.

In step 123, the processor of the head-mounted display enables the transmission interface to transform the current image into a plurality of characteristic values and generates space information. It then transmits these characteristic values and the space information to the server SR.

In step 124, the server SR applies these characteristic values and the space information to update a partial map that corresponds to the current location thereby building a new version of partial map.

In step 125, the server updates a map version number and stores the new version of partial map.

In an embodiment, when the head-mounted display moves, repeating the steps 121˜125 can keep the latest indoor space positioning information.

As described above, the embodiments of the present invention provide an indoor space positioning system and an indoor space positioning method, which can implement the effect of obtaining same tracking positioning results between different users in the indoor by downloading the partial share map. The embodiments of the present invention can also perform more precise positioning and/or updating the positioning information of the indoor space by dividing the indoor space into multiple blocks.

While the invention has been described by way of the preferred embodiments, it should be understood that the invention is not limited to the disclosed embodiments. Those skilled in the art can make some modifications and arrangements without leaving the scope of the present invention. Therefore, the scope of the appended claims should be accorded to the appended claims.

What is claimed is:

1. An indoor space positioning method, comprising:
capturing an initial image using a camera in a head-mounted display (HMD);
enabling a transmission interface to download an initial share map that corresponds to the initial image from a server and locating the head-mounted display at an initial location in an indoor space, via a processor in the head-mounted display; and
applying a simultaneous localization and mapping (SLAM) algorithm to track a current location of the head-mounted display via the processor.

2. The indoor space positioning method as claimed in claim 1, wherein the initial image is a QR code (Quick Response Code), and the server determines that the head-mounted display is at the initial location in the indoor space according to information represented by the QR code.

3. The indoor space positioning method as claimed in claim 2, wherein the transmission interface is enabled via the processor in the head-mounted display to download an important share map that corresponds to the respective important QR codes from the server.

4. The indoor space positioning method as claimed in claim 1, further comprising:
enabling the transmission interface to download a plurality of partial share maps which are within a spatial range of the initial share map that corresponds to the initial image from the server, via the processor in the head-mounted display.

5. The indoor space positioning method as claimed in claim 1, further comprising:
enabling the transmission interface to download a plurality of partial share maps which are adjacent to the initial share map that corresponds to the initial image from the server, via the processor in the head-mounted display.

6. The indoor space positioning method as claimed in claim 1, further comprising:
dividing the indoor space into a plurality of blocks via the processor, each of the blocks corresponding to a partial share map; and
enabling the transmission interface to download the partial share maps which surround the initial share map that corresponds to the initial image from the server, via the processor in the head-mounted display.

7. The indoor space positioning method as claimed in claim 6, wherein the processor enables the transmission interface to download a current share map that corresponds to a current location and a plurality of current partial maps adjacent to the current share map from the server, when the head-mounted display moves.

8. The indoor space positioning method as claimed in claim 1, wherein the processor downloads a plurality of important share maps from the server first when the processor applies the simultaneous localization and mapping algorithm to track the current location of the head-mounted display.

9. The indoor space positioning method as claimed in claim 8, wherein the processor downloads a plurality of secondary share maps from the server after the processor downloads the important share maps from the server.

10. The indoor space positioning method as claimed in claim 1, wherein when the processor tracks the head-mounted display and detects that the head-mounted display moves to a current location, the camera captures a current image, the processor enables the transmission interface to transform the current image into a plurality of characteristic values and generate a space information, then transmits the characteristic values and the space information to the server, and the server applies the characteristic values and the space information to update a partial map that corresponds to the current location thereby building a new version of partial map;
wherein the server updates a map version number and stores the new version of partial map, after the new version partial map is built.

11. An indoor space positioning system, comprising:
a camera, arranged in a head-mounted display (HMD) and configured to capture an initial image; and
a processor, arranged in the head-mounted display, wherein the processor enables a transmission interface to download the initial share map that corresponds to the initial image from a server and locates the head-mounted display at an initial location in an indoor space;
wherein the processor applies a simultaneous localization and mapping (SLAM) algorithm to track a current location of the head-mounted display.

12. The indoor space positioning system as claimed in claim 11, wherein the initial image is a QR code (Quick Response Code), and the server determines that the head-mounted display is at the initial location in the indoor space according to information represented by the QR code.

13. The indoor space positioning system as claimed in claim 12, wherein the transmission interface is enabled to download an important share map that corresponds to the respective important QR codes from the server via the processor in the head-mounted display.

14. The indoor space positioning system as claimed in claim 11, wherein the processor in the head-mounted display enables the transmission interface to download a plurality of partial share maps which are within a spatial range of the initial share map that corresponds to the initial image from the server.

15. The indoor space positioning system as claimed in claim 11, wherein the processor in the head-mounted display enables the transmission interface to download a plurality of partial share maps which are adjacent to the initial share map that corresponds to the initial image from the server.

16. The indoor space positioning system as claimed in claim 11, wherein the processor divides the indoor space into a plurality of blocks, and each of the blocks corresponds to a partial share map;
wherein the processor in the head-mounted display enables the transmission interface to download the partial share maps which surround the initial share map that corresponds to the initial image from the server.

17. The indoor space positioning system as claimed in claim 11, wherein when the head-mounted display moves, the processor enables the transmission interface to download from the server a current share map that corresponds to a current location and a plurality of current partial maps adjacent to the current share map.

18. The indoor space positioning system as claimed in claim 11, wherein the processor downloads a plurality of important share maps from the server first when the processor applies the simultaneous localization and mapping algorithm to track the current location of the head-mounted display.

19. The indoor space positioning system as claimed in claim 18, wherein the processor downloads a plurality of secondary share maps from the server after the processor downloads the important share maps from the server.

20. The indoor space positioning system as claimed in claim 11, wherein when the processor tracks the head-mounted display and detects that the head-mounted display moves to a current location the camera captures a current image, the processor enables the transmission interface to transform the current image into a plurality of characteristic values and generate space information, then transmits the characteristic values and the space information to the server, and the server applies the characteristic values and the space information to update a partial map that corresponds to the current location thereby building a new version of partial map;
wherein the server updates a map version number and stores the new version of partial map, after the new version partial map is built.
